(19) United States
(12) Patent Application Publication
(10) Pub. No.: US 2006/0200394 A1
(43) Pub. Date: Sep. 7, 2006

(54) Method for monitoring securities and market conditions

(75) Inventors: Paresh J. Malde, Okemos, MI (US); Anand Uday, Lansing, MI (US); Abhishek Jha, Lansing, MI (US); Saaj M. Shah, E. Lansing, MI (US)

Correspondence Address: CLARK HILL, P.C., 500 WOODWARD AVENUE, SUITE 3500, DETROIT, MI, 48226, US

(73) Assignee: Avadhi Finance & Technology, Inc., Okemos, MI (US)

(21) Appl. No.: 11/072,478

(22) Filed: Mar. 4, 2005

(51) Int. Cl. G06Q 40/00

(52) U.S. Cl. 705/35

(57) ABSTRACT

A method is disclosed for performing an action associated with a security in a market that has a plurality of conditions. The method includes the steps of identifying the security. Once the security is identified, an action is selected which will be taken at a certain time. A portion of the plurality of conditions are chose. Parameters are set for each of the conditions that are to be met. The action is then performed with regard to that security when the parameters for each of the conditions is met. The method provides for the monitoring of several securities and several conditions for each of the securities. The conditions that are being watched for each security may be different and may be edited on the fly independently of the conditions being watched for the other securities, which continue to be monitored even during the editing of the other security.

### BACKGROUND ART

1. Field of the Invention

The invention relates to a method for monitoring securities. More specifically, the invention relates to a method for monitoring a plurality of conditions to determine if and when particular actions are to be taken.

2. Description of the Related Art

An enormous effort is made to monitor securities to determine when the best time to trade those securities. For purposes of this patent application, securities include stocks, bonds, treasury notes, commodities, and precious metals. It should be noted that this list is not exhaustive and may include other types of items that are traded in markets.

Securities in markets have been watched and monitored since there was something to trade. As technology progressed, so did the amount of monitoring. From ticker tape machines to televisions, people monitor different securities to determine whether a trade of those securities is optimal. Regardless of the sophistication of the device transmitting the information to the trader, or how fast the data is transmitted to the trader, the information being monitored is primarily price. Traders trade securities based on the price of the security. Even as individual traders are able to stream data into their personal computers, the data that they stream is price.

U.S. Pat. No. 6,594,643 discloses an automatic stock trading system. This system automatically makes trades of stocks without manual intervention. The only condition monitored by this automatic stock trading system is the price of shares. The amounts of shares being traded may be graduated based on price, but the only condition monitored by the system is price.

While price is a condition that is very important in determining when a security is traded, it is a myopic view of the marketplace. More specifically, the marketplace includes several variables, only one of which is price. Markets go up and down, disclosures are made regarding raw materials for particular goods, natural disasters occur, the flow of money between nations changes, currency fluctuates and the like. All of these factors, as well as other factors not listed, affect whether a trade of a security is made by a particular person with a particular set of personal requirements. Yet none of these systems designed to monitor securities look at these conditions separately or as groups.

### SUMMARY OF THE INVENTION

A method is disclosed for performing an action associated with a security in a market that has a plurality of conditions. The method includes the steps of identifying the security. Once the security is identified, an action is selected which will be taken at a certain time. A portion of the plurality of conditions is chosen. Parameters are set for each of the portion of the plurality of conditions that are to be met. The action is then performed with regard to that security when each of the parameters for each of the portion of the plurality of conditions is met.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a logic chart identifying the architecture of a system incorporating the inventive method;

FIG. 2 is a system process flow chart;

FIG. 3 is a logic chart of the method; and

FIGS. 4.1 through 5.2 are screens shots of various conditional trading schema utilizing the inventive method.

### DETAILED DESCRIPTION OF THE PREFERRED EMBODIMENT

The invention is a system that allows a user to track events in a financial market and to take actions with regard to those events. The events that may occur include conditions found in multiple markets. These conditions may be specifically directed toward a particular security, group of securities, market conditions, world events, and the like. This list is not exhaustive. When a condition or a set of conditions is met, an action is taken. The action may be an email notification, a web browser-based notification (pop-up window), a trigger for the system to watch other conditions, or automatic trading of specific securities.

The invention provides a user with the ability to track a plurality of conditions and, the ability to identify when those conditions are met. Once the conditions are true or met, the system will automatically perform the action that is defined by the user when the conditional tests were set up.

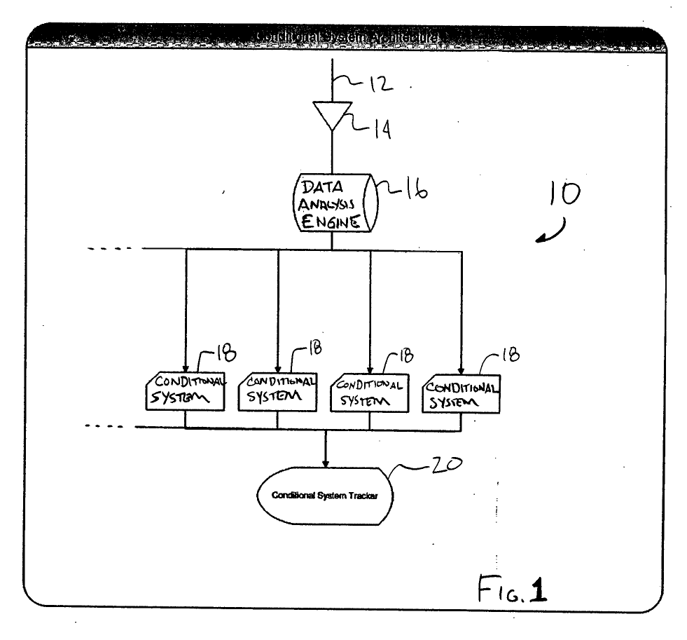

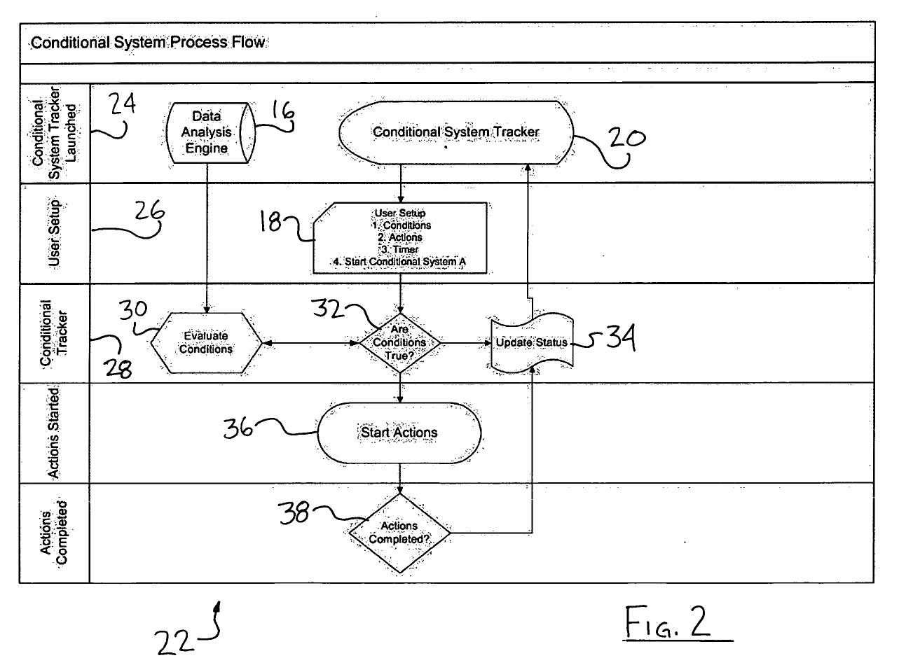

Referring to FIG. 1, the architecture for software that operates the inventive method is generally indicated at 10. The system has an input 12 where data is received. The data received through the input 12 is a market data stream. The market data stream is all information that is presented in real time. The market data may also include things outside of traditional markets as determined by the user. This information is collected at 14 and presented to a data analysis engine 16. The data analysis engine 16 is a module that processes the data streaming through the input 12. The data analysis engine 16 may perform calculations or query for specific data, depending on the values found within the data stream. The queries are set up by the user, the process of which will be discussed in greater detail subsequently.

Data from the data analysis engine 16 is then transmitted to a conditional system 18. The conditional system 18 takes the information needed from the data analysis engine and determines whether conditions are met based on what the user has identified as particular conditions being tested. As may be seen in FIG. 1, a plurality of conditional systems 18 may be running at the same time in parallel. Data from the data analysis engine 16 may go to one or more of the conditional systems 18 that are running at the time. The conditional systems 18 are set up by the user and may be stored in memory for continued use after any particular trading day has terminated.

As conditions are met, information regarding those conditions is transmitted to the conditional system tracker 20. The conditional system tracker 20 allows the users to track the status of the particular conditions that are being watched. The conditional system tracker 20 also provides the means to monitor and/or implement the actions that are defined by the user which must occur when the conditions of a particular conditional system 18 are met. Inputs received by the conditional system tracker 20 which are generated by the user are transmitted back to the conditional systems 18. This is the branch where the conditional systems 18 are modified based on the desired requirements of the user.

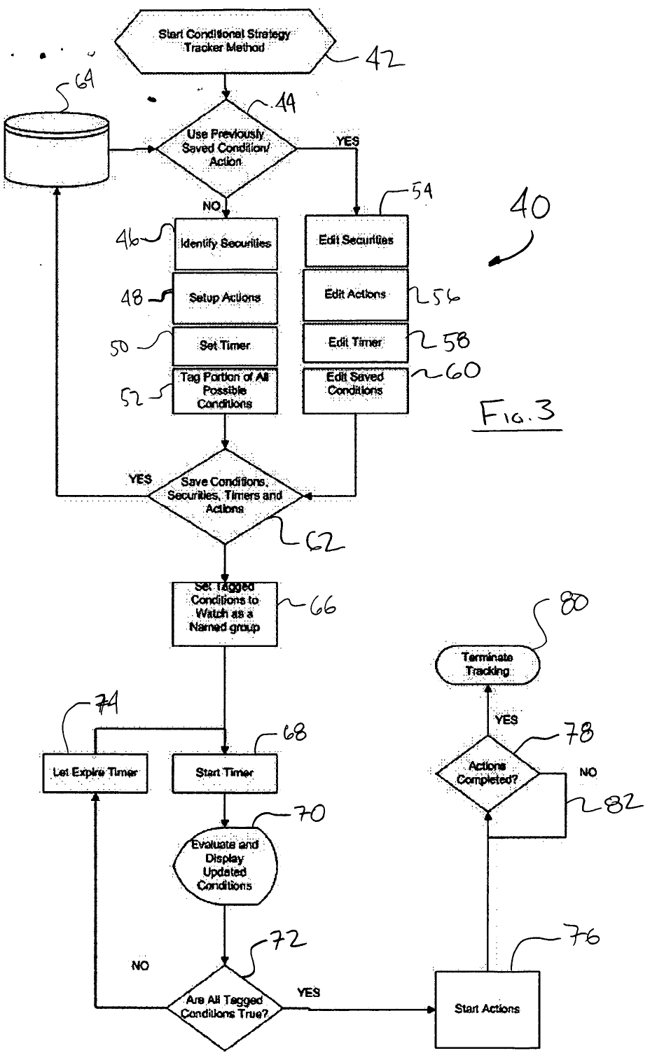

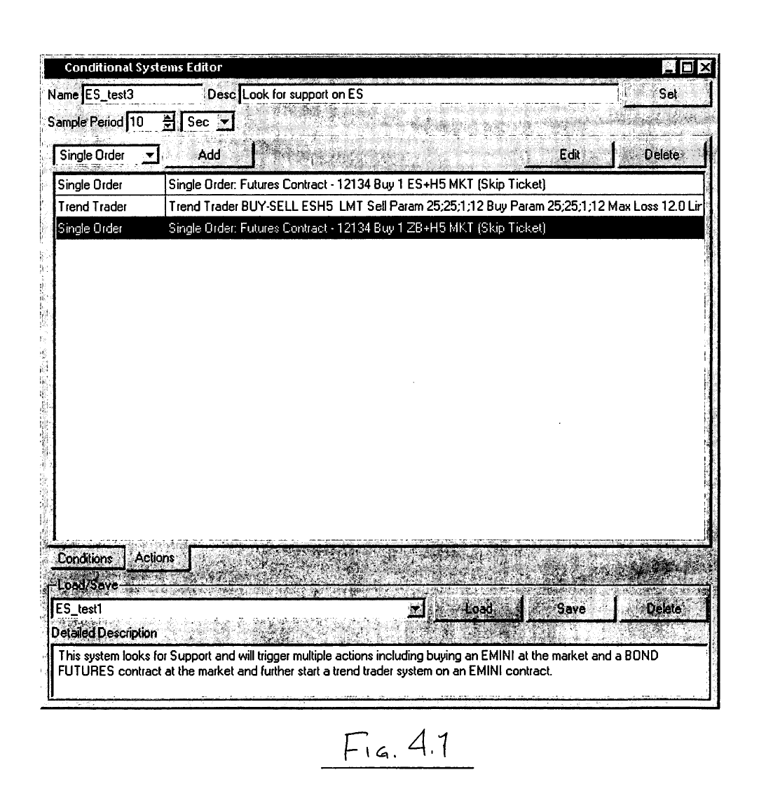

Referring to FIG. 2, the process flow for the conditional system is generally indicated at 22. The system is launched at 24 where the data analysis engine 16 and the conditional system tracker 20 receive data from both the market data stream and the user. User set up occurs at 26 wherein the conditional system 18 is initialized. In particular, the user set up includes defining the conditions that are to be monitored, defining the actions to be taken should the conditions be met, and a timer to determine how frequently a periodic review of the status of the conditions is to be made. The conditional tracker 20 begins its work at 28. The conditional tracker evaluates conditions at 30. A test at 32 determines whether the conditions are met. The status of the conditions is updated at 34. Actions are taken at 36. Once the actions are completed at 38, the status is updated at 34. All status updates are then transmitted to the conditional system tracker 20. This represents how the data flows when the inventive method is being employed.

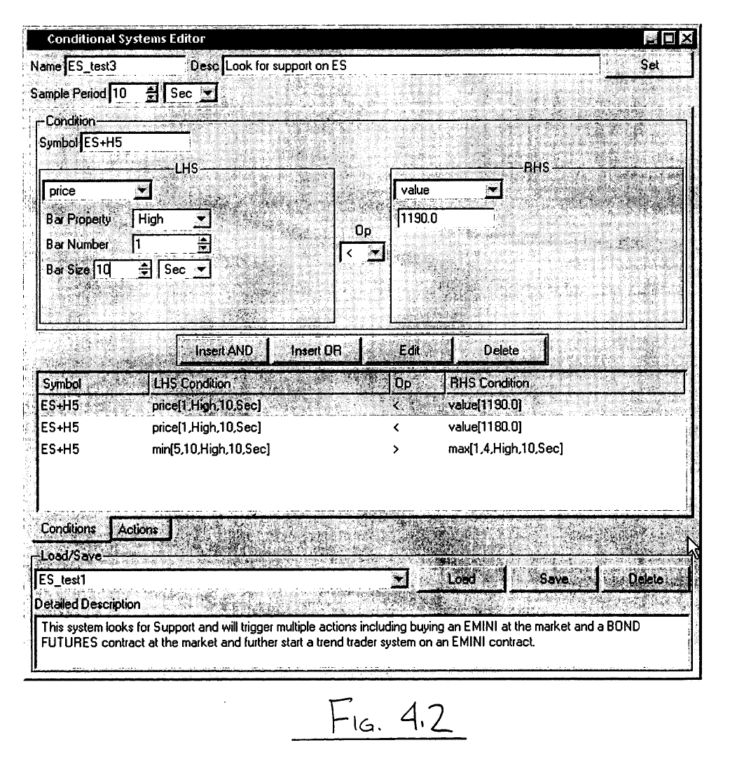

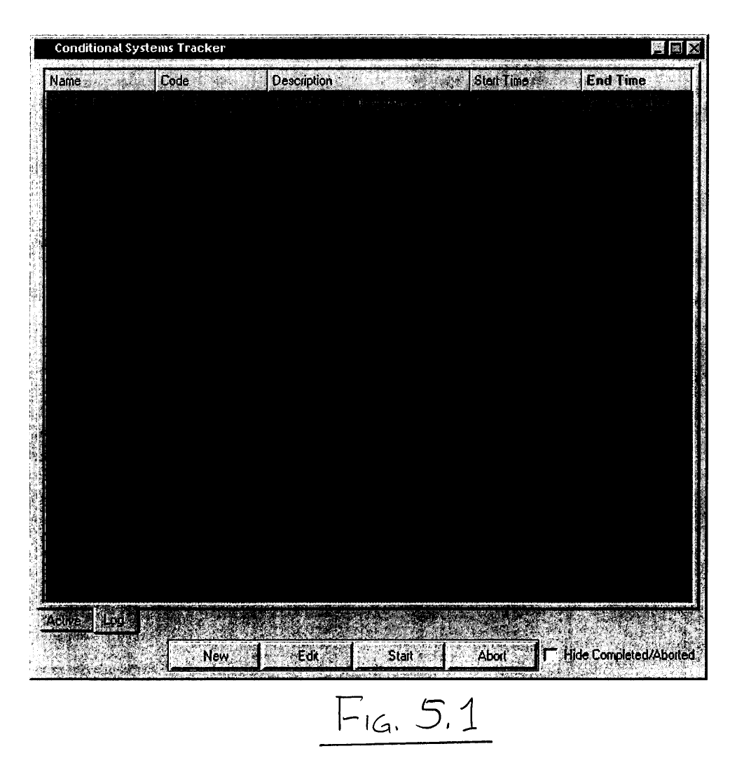

Referring to FIG. 3, a graphic representation of the inventive method is generally indicated at 40. The graphic representation of the method 40 is a logic chart identifying the steps through which the method takes in order to operate. The method begins at 42. It is immediately determined at 44 whether a previously save condition set is to be used or, in the alternative, whether a new condition set is to be generated. If a new set of conditions are to be created to generate a particular action or actions, the method proceeds to 46 where it identifies the securities that are to be acted upon. Once the securities are identified, the defined actions are set up at 48. The particular actions that are set up identify what is going to occur should particular conditions be met. As stated above and by way of example, actions may include trading securities, notifying a user via email or pop-up window that conditions are met, or any combination of the above. In addition, an action may be to invoke another set of conditions that are to be watched and as such, the inventive method 40 will generate a new set of conditions based on the completion of a previous set of conditions.

Once the actions are established at 48, a timer is set at 50. The timer identifies the period in which the conditions are going to be tested. For example, a timer may be set such that it will check the rate at which a stock price is changing every twenty seconds. The timer may be set for any time period desired by the user.

Once the timer is set, a portion of all possible conditions is tagged at 52. A condition is anything that may occur that might affect a user and the user's desire to trade a particular security. A condition may be a stock price, a stock price limit, a rate at which a stock price is changing, whether the rate of a stock price change is positive or negative, currency exchanged rate, changes in complete market sectors, volumes at which particular securities are being traded, world events, and the like. It should be appreciated that there are an infinite number of conditions that could be selected by a user in determining whether an action is to be taken with regard to a particular security or sets of securities. Choosing all of the conditions as a possibility to determine whether an action should be taken would render the method 40 useless. This is because a user would not have any analysis performed by the method 40 that isn't already being done by the user through normal channels of communication. In addition, as with the normal channels of communication, the amount of information would be so great that any true analysis on the part of the user would be as effective as if the user did not use the method 40.

Returning our attention to step 44, which is determining whether a previously saved condition set or action is to be take: the method allows the user to edit the security at 54. Likewise, the actions are edited at 56, the timer is edited at 58, and the conditions are edited at 60. The edits themselves maybe the saving of previously saved data or changes may be implemented at this time.

The method 40 then determines whether the conditional system 18 has been saved previously. This step occurs at 62. If the conditional system 18 is required to be saved because information has changed, it is done so at 64. If the conditional system 18 does not need to be saved, it is because none of the parameters that define the conditional system 18 were changed. If that is the case, the conditional system is named at 66. This allows a user to invoke a named conditional system 18 which will allow the user the opportunity to easily identify which of the conditional systems 18 the user would like to have in operation at that time.

Once named, the timer is started at 68. Conditions are evaluated at 70. The values of the conditions are displayed at this time. A test at 72 determines whether all the tagged conditions are true. If not, the method loops back at 74 and allows the timer to expire before the timer is started again at 68. This provides a loop to continue testing all the conditions periodically.

If all the conditions are true the action or actions are started at 76. Once it is determined that the actions are completed, at 78, the conditional system 18 is terminated at 80. If the action is not completed, the method loops back at 82 as long as it takes to have the action completed.

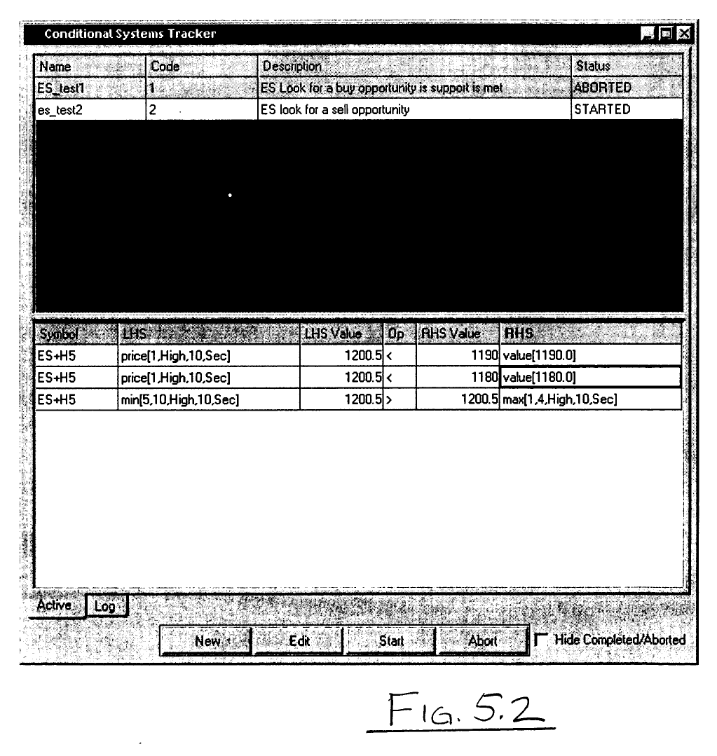

Referring to FIGS. 4.1 through 5.2, representations of outputs of the inventive method 40 are shown. These screens would occur during the user set up phase 26 of the process flow and at the step of the inventive method 70 that evaluates and displays updated conditions. In FIG. 4.1, the screen illustrates the monitoring portion of the system. In this monitoring portion, a selection may be made as to which section of the monitoring portion the operator may wish to perform. The two sections are the active section and the log of completed/aborted section. From the active section, the user is able to start and/or abort a conditional system that is in “ready mode.” The user can also select the named conditional systems on the top window and the system display the real-time state of the conditions in the bottom window. The LHS and the RHS conditions as set up by the user are displayed, along with the state of each condition.

If the conditional system is running, the conditional system will display in real-time the values of the left hand side (LHS) and right had side (RHS) of the functions for which the system is set. If one of the conditions is currently true, that particular row will be displayed in green (or a user defined color); if one of the conditions has been true since the conditional system was started, the color of that row will change from green to yellow (or a user-defined color) indicating to observers that the particular condition was once true but is currently false. If any of the conditions have remained false, then the colors of those rows will not change. By launching the conditional system editor, the user can also create new conditional systems from this window or can edit a system that is running. The user is also able to start a system that was is in a “ready” mode by right-clicking on the system or by selecting the named system row and pressing start.

FIG. 4.2 illustrates the conditional systems that have been completed or have been aborted by the user. FIG. 5.1 represents the conditional system editor, which is invoked from the conditional system tracker window. The editor is used by the users for several functions. A user may create new conditional systems, edit existing conditional systems, associate conditional systems with names, and save the conditional systems. The front screen is where the user sets up the actual conditions, securities and the timer settings. By pressing the actions tab, the user will be able to setup the actions associated with a system. Once the user has “programmed” the conditions and the actions, the user can then “set” the particular system into the tracker window and it will appear as a line-item with the label “ready.”

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A method for performing an action associated with a security in a market having a plurality of conditions, the method comprising the steps of:
identifying the security;
selecting the action to be taken;
choosing a portion of the plurality of conditions;
setting a parameter for each of the portion of the plurality of conditions to be met; and
performing the action with regard to the security when the parameters for each of the portion of the plurality of conditions is met.

2. A method as set forth in claim 1 including the step of tagging each of the portion of the plurality of conditions to create a tagged set of conditions.

3. A method as set forth in claim 2 including the step of storing the tagged set of conditions in memory.

4. A method as set forth in claim 3 including the step of periodically invoking the tagged set of conditions to watch the portion of the plurality of conditions.

5. A method as set forth in claim 4 including the step of naming the tagged set of conditions.

6. A method as set forth in claim 5 including terminating the step of periodically invoking after the parameters for each of the portions of the plurality of conditions is met.

7. A method as set forth in claim 6 including the step of identifying a plurality of securities.

8. A method as set forth in claim 7 including the step of identifying a plurality of securities in a plurality of markets.

9. A method as set forth in claim 8 including the step of choosing the portion of the plurality of conditions from a plurality of markets.

10. A method as set forth in claim 9 including the step of selecting the portion of conditions and the plurality of securities using a computer graphic user interface.

11. A method as set forth in claim 10 including the step of choosing a plurality of portions of the plurality of conditions, each of the plurality of portions running parallel to each other.

12. A method as set forth in claim 11 including the step of receiving data regarding securities and markets in real time.

13. A method as set forth in claim 12 including the step of analyzing the data.
